(19) United States
(12) Patent Application Publication
(10) Pub. No.: US 2014/0222410 A1
(43) Pub. Date: Aug. 7, 2014

(54) HYBRID EMULATION AND KERNEL FUNCTION PROCESSING SYSTEMS AND METHODS

(71) Applicants: Xiao Dong Lin, Shanghai (CN); Yihua Jin, Shanghai (CN); Yong Wu, Shanghai (CN); Jianhui Li, Shanghai (CN); Ling Lin, Shanghai (CN); Xingdong Shi, Shanghai (CN)

(72) Inventors: Xiao Dong Lin, Shanghai (CN); Yihua Jin, Shanghai (CN); Yong Wu, Shanghai (CN); Jianhui Li, Shanghai (CN); Ling Lin, Shanghai (CN); Xingdong Shi, Shanghai (CN)

(21) Appl. No.: 13/994,713

(22) PCT Filed: Mar. 22, 2012
(86) PCT No.: PCT/CN2012/072780

§ 371 Date: Jun. 15, 2013

(51) Int. Cl. G06F 9/455

(52) U.S. Cl. CPC G06F 9/4552
USPC 703/23

(57) ABSTRACT

One embodiment pre-builds translations of kernel functions (KFs) and loads them into a translation pool and corresponding indexed table. The KFs are thus quickly loaded and do not necessarily await trapping and emulation via a LIB emulator. This results in faster access to KFs. Other embodiments provide hybrid emulation where some application functions (e.g., those that need quick performance) are translated from a source ISA library while other applications functions are processed via emulation to a target ISA library. Doing so provides faster access to certain functions. Other embodiments are described herein.

### BACKGROUND

A computing device may be characterized by its Instruction Set Architecture (ISA). Typically, a computing device may include Operating System (OS) services, and the OS services may include the runtime library (LIB) services, developed for the ISA of the computing device, to help application developers develop applications to operate on the computing device. If the application is written for an ISA other than the ISA for the computing device, the application may need to be emulated. Specifically, emulation allows an application (written for a first ISA) to execute on a computing device's architecture (which uses a second ISA) and access runtime LIB services of the target platform. Further, ISA dependent portions of applications may include callback functions (e.g., functions that call back from an ISA dependent runtime LIB to an emulated application, functions that call back to source LIB services that need to be emulated).

However, emulation may encounter challenges due to a lack of hardware capability between ISAs. For example, a source ISA may implement some functionality not provided by the underlying target ISA. Such functionality may include an atomic operation, which is indivisible and irreducible such that the atomic operation must be performed entirely or not performed at all (e.g., such an operation may include a processor simultaneously reading a location and writing to a location in the same bus operation).

In other instances, items such as kernel functions (KF) may be employed that are independent of source or target ISAs. A KF is not a functionality provided by an ISA but instead is related to the functionality provided by the OS of the underlying platform (e.g., LIB services 124 discussed further below). The emulation of the KF may encounter challenges not due to a lack of the hardware capability as discussed above but instead due to the different capabilities between source and target LIB services. A KF may include a function that accesses kernel data and operates in kernel space but which does not require a context switch between the source application and its host emulation machine. Thus, using a KF allows quick access to kernel data but also avoids the overhead of context switch between guest and host emulation machines or environments. Still, a KF may still incur the overhead of a context switch if it is incorrectly trapped by the host emulation machine.

Emulation may further encounter challenges due to the size of content that is to be emulated. For example, a mobile platform may face challenges emulating entire libraries (which may be very large) when only select functions truly need to be emulated.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates a computing device including ISA bridging in an embodiment of the invention;

FIG. 2 illustrates the ISA bridging layer of FIG. 1 in further detail;

FIGS. 3 and 4 illustrate methods for bridging calls and callbacks between an application of a source ISA and LIB services of a target ISA in embodiments of the invention;

FIG. 5 includes an embodiment for efficient KF processing.

FIGS. 6-7 include an embodiment for hybrid emulation.

### DETAILED DESCRIPTION

Various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted. The phrase “embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”.

One embodiment pre-builds translations of KFs and loads them into a translation pool and corresponding indexed table. The KFs are thus quickly loaded and do not necessarily await trapping and emulation via a LIB emulator. This results in faster access to KFs. Other embodiments provide hybrid emulation where some application functions (e.g., those that need quick performance) are translated from a source ISA library while other applications functions are processed via emulation to a target ISA library. Doing so provides faster access to certain functions.

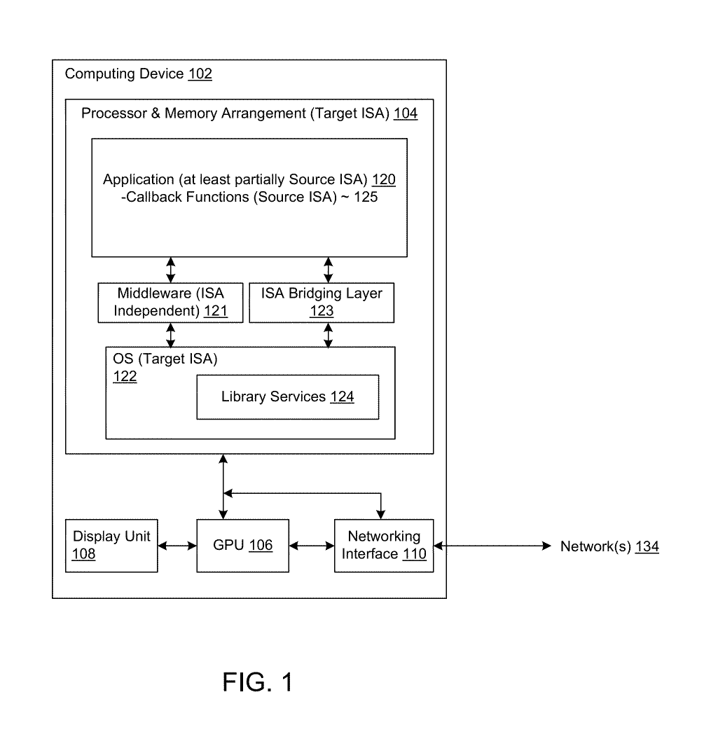

FIG. 1 illustrates an example computing device including ISA bridging (optionally with callback) in an embodiment. Computing device 102 may include processor and memory arrangement 104, which includes or couples to OS 122, ISA bridging layer 123, application 120, graphics processing unit (GPU) 106, display unit 108, and networking interface 110, coupled (i.e., directly or indirectly) with each other as shown. OS 122 may include a LIB of services 124. Computing device 102 may also include optional middleware 121 between application 120 and OS 122. As will be described in more detail below, ISA bridging layer 123 may be configured with various runtime features and services to enable application 120 to be implemented in a source ISA in whole or in part (e.g., when an ISA-independent middleware 121 is also used), while OS 122 (including LIB services 124) may be implemented in a target ISA that is different from the source ISA. Further, application 120 may be an application (in particular, the portion implemented using source ISA) that includes usage characteristics of LIB services 124 that require various elements (e.g., functions) of LIB services 124 to “callback” various callback functions 125 of application 120 under various conditions. ISA bridging layer 123 may also be referred to herein as a process virtual machine (PVM).

Computing device 102 may be a server, desktop computer, laptop computer, tablet computer, Smartphone, personal digital assistant, game console, Internet appliance, mobile internet device, cell phone, mobile networking device, mobile computing node, or other computing device. Processor and memory arrangement 104 represents a broad range of processor and memory arrangements including arrangements with single or multi-core processors of various execution speeds and power consumptions, and memory of various architectures (e.g., with one or more levels of caches) and various types (e.g., dynamic random access, FLASH, and so forth). In various embodiments, GPU 106 may be configured to provide video decoding and/or graphics processing functions to OS 122, while display unit 108 may be configured to enable multi-media content (e.g., HD video) to be rendered thereon. Similarly, GPU 106 and display unit 108 are intended to represent a broad range of graphics processors and display elements known in the art. Likewise, network(s) 134 is (are) intended to represent a broad range of networks. Examples of network(s) 134 may include wired or wireless, local or wide area, private or public networks, including the Internet. OS 122 (including LIB services 124), except for the application programming interface (API) defining invocation of LIB service 124, represents a broad range of OS elements known in the art. OS 122 may include conventional components such as a kernel configured to manage memory resources, schedule task execution, and so forth, and device drivers configured to manage various device resources. In embodiments, OS 122 may include a virtual machine in support of optional middleware 121 (e.g., Android™ virtual machine in support of the Android™ application framework). In addition to defining invocations of LIB services 124, to facilitate invocation of callback functions 125 of application 120 the API of LIB services 124 may also include the corresponding stubs and signatures of callback functions 125 of application 120. Examples of OS 122 may include Windows® operating systems, Linux®, Android™, iOS®, and the like. Similarly, optional middleware 121 is intended to represent a broad range of middleware elements including, but not limited to, ISA-independent middleware. Examples of middleware 121 may include, but are not limited to, Android™ Application Framework, Java™, or other application frameworks or ISA-independent execution environments. Likewise, application 120 (including callback functions 125) represents a broad range of applications including applications for personal assistant, productivity, social networking applications, calendaring, word processing, spreadsheets, Twitter®, Facebook®, browsers, and the like.

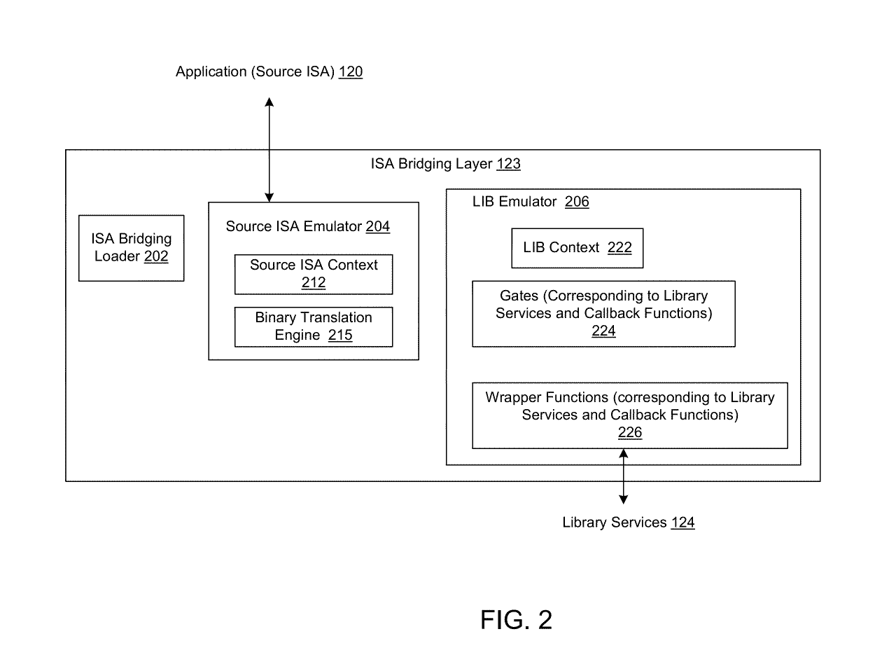

In FIG. 2 ISA bridging layer 123 may include ISA bridging loader 202, source ISA emulator 204, and target ISA LIB emulator 206 (configured to provide various runtime features and services including dynamic binding services). Source ISA emulator 204 may include source ISA context 212, and binary translation engine 215. Source ISA emulator 204 may maintain in source ISA context 212 the execution context of source ISA architecture including, for example, the current execution instruction pointer (IP). Binary translator engine 215 may be configured to translate source ISA instructions to target ISA instructions. LIB emulator 206 may include target ISA LIB context 222, gates 224 (e.g., data structure used by a processor to control access to privileged functions, change data segments, switch tables, and the like), and wrapper functions 226. LIB emulator 206 may maintain in target ISA LIB context 222 the execution context of target ISA LIB 124. In various embodiments, there may be a corresponding gate 224 and wrapper function 226 pair for every LIB service 124 (e.g., function), with the pair being configured to facilitate the calling of LIB service 124 by application 120, across the source and target ISA architectures. Similarly, there may be one corresponding pair of gate 224 and wrapper function 226 per callback function 125, configured to facilitate callback of callback function 125 by LIB services 124, across the target and source ISA architectures.

ISA bridging loader 202 may be a utility configured to load application 120 into memory. In loading application 120, ISA bridging loader 202 may be configured to resolve any unresolved symbols 126 of application 120 associated with a LIB that corresponds to source application 120. A symbol may be an identifier (e.g., text string) of a register, memory address, and the like. ISA bridging loader 202 may be configured to modify the symbols (to callback functions 125), and associate the symbols for callback functions 125 to the corresponding wrapper functions 226. ISA bridging loader 202 may gain control of loading from the loader (not shown) of OS 122 (or middleware 121, if employed) in any one of a number of known manners including the use of binary format based control transfer or load/pre-load variables when supported by OS 122 or middleware 121. In other embodiments, the loader of OS 122 (or middleware 121, if employed) may be modified to facilitate the transfer of control to ISA bridging loader 202 instead.

Source ISA emulator 204 may emulate source ISA 120 “on top of” target ISA 122 to run source ISA application 120. As described earlier, source ISA emulator 204 may be configured to maintain source ISA execution context 212. For example, source ISA emulator 204 may be configured to track the source ISA IP during execution of application 120. When application 120 attempts to invoke a LIB service 124, source ISA emulator 204 may be monitoring source ISA execution and may invoke and transfer execution control to LIB emulator 206 instead. In various embodiments, source ISA emulator 204 may invoke and transfer execution control to the corresponding gate 224 (discussed further below) of LIB service 124.

LIB emulator 206 may emulate a source LIB (or any other LIB) through mapping to target LIB 124. Also, LIB emulator 206 may be configured to maintain target ISA LIB (LIB) execution context 222. Gates 224 corresponding to LIB services 124 may be configured to respectively redirect calls to LIB services 124 and to corresponding wrapper functions 226 that process and set up the calls. Gates 224 corresponding to callback functions 125 may be configured to respectively transfer execution control for callbacks from the corresponding wrapper functions 226 to source ISA emulator 204. In various embodiments, each gate 224 may include an instruction configured to effectuate redirection to the corresponding wrapper function 226 or source ISA emulator 204. In various embodiments, the instruction of each gate 224 may be a source ISA instruction configured to cooperate with the binary translation engine 215 to effectuate execution control redirection. In various embodiments, each gate 224 may further include an indicator identifying the corresponding wrapper function 226.

In various embodiments, for processing and setting up a call to the corresponding LIB service 124, each wrapper function 226 corresponding to a LIB service 124 may be configured to retrieve the associated parameter values of the call from source ISA context 212, convert the call from the source ISA application binary interface (ABI) format to the target ISA ABI format, and save the converted call with the parameter values in LIB context 222. On a callback to a callback function 125, execution control may be transferred to the corresponding wrapper function 226 of callback function 125. In various embodiments, for processing and setting up a callback to a callback function 125 of application 120, each wrapper function 226 corresponding to a callback function 125 may be configured to convert the callback from the target ISA ABI format to the source ISA ABI format, attach the associated parameter values of the callback, and save the converted callback with the parameter values in source ISA context 212. Gates 224 corresponding to a callback function 125 may be configured to invoke the source ISA emulator 204 with the source ISA context 212 (prepared by wrapper function 226 and corresponding to the callback function 125) to emulate the callback function presented in Source ISA format on target ISA 104.

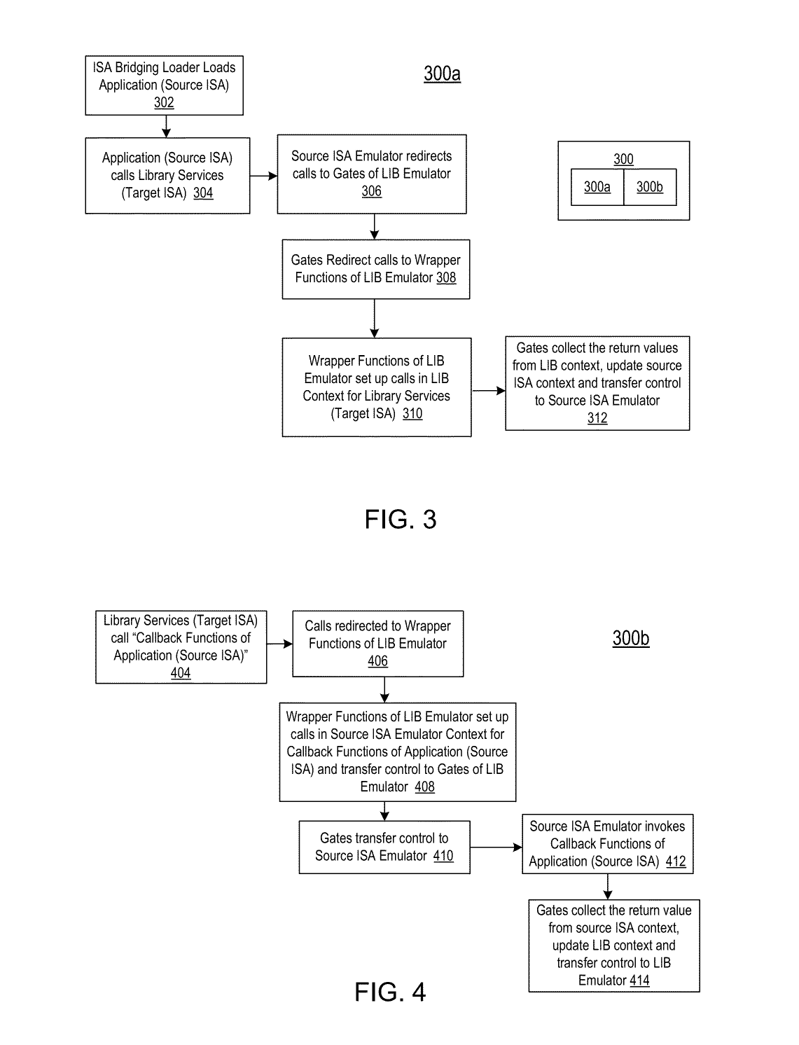

FIGS. 3-4 illustrate an example ISA bridging method with callback in accordance with embodiments of the invention. Method 300 may include two parts, part 300a for bridging calls from application 120 (of source ISA) to LIB services 124 (of target ISA), and part 300b for bridging callbacks from a LIB service 124 (of target ISA) to a callback function 125 of application 120 (of source ISA). Parts 300a and 300b may be implemented independently of one another. Also, various embodiments need not concern wrapper functions and/or callback functions but may instead focus on other facets of embodiments described herein.

In FIG. 3 at block 302, ISA bridging loader 202 may load source application 120. In loading application 120, ISA bridging loader 202 may resolve symbolic names or references 126 to LIB services 124, and modify symbolic names or references of callback functions 125, as earlier described. In block 304, in the course of execution application 120 may call one of LIB services 124. In various embodiments, application 120 may require a callback to one of its callback functions 125 by the called LIB service 124. In embodiments, application 120 may include as part of the call to the called LIB service 124 a pointer to a callback function 125. Instead of passing the pointer to the callback function 125, the wrapper function 226 of the LIB service 124 may pass the corresponding wrapper function 226 of the call back function 125. At block 306 source ISA emulator 204, on detection of the call (e.g., through monitoring of the source ISA IP and determining that the IP is referencing an address within the address scope of the target LIB), may redirect the call and transfer execution control to the corresponding gate 224 of the LIB service 124 in LIB emulator 206. At block 308, the appropriate gate from gates 224 may further redirect the call and transfer execution control to the corresponding wrapper function 226 of the called LIB service 124. At block 310, wrapper function 226 of the called LIB service 124 may process the call, and set up the call in LIB context 222 for execution by the called LIB service 124, as earlier described. At block 312, gate 224 of the called LIB service 124 may collect the return value(s) of the call from LIB context 222, update source ISA context 212, and transfer execution control to source ISA emulator 202.

In FIG. 4 (part 300b) at block 404, in the course of or upon completion of a called LIB service 124, LIB service 124 may callback a callback function 125 of application 120 (e.g., by calling the callback pointer passed by application 120). At block 406, execution control may be transferred to the corresponding wrapper function 226 of callback function 125, in accordance with the modified reference. At block 408, wrapper function 226 may process the callback, set up the callback in source ISA context 212 for execution by the callback function 125 of application 120, as described earlier, and thereafter, transfer execution control to the corresponding gate 224 of the callback function 125. At block 410, gate 224 corresponding to the callback function 125 may redirect the callback and transfer execution control to the ISA emulator with the source ISA context prepared by the wrapper function 226. At block 412, source ISA emulator 204 may start the emulation of the call back function according to the IP within the source ISA context. At block 414, gate 224 of the callback function 125 may collect the return value(s) of the callback from source ISA context 212, update LIB context 222, and transfer execution control to LIB emulator 204 to return the return values of the callback function 125 to the LIB service 124.

Embodiments of the invention may utilize emulation environments, such as any of the embodiments of FIGS. 1-4, with KFs to provide efficient access to kernel data while still providing emulation for other functions.

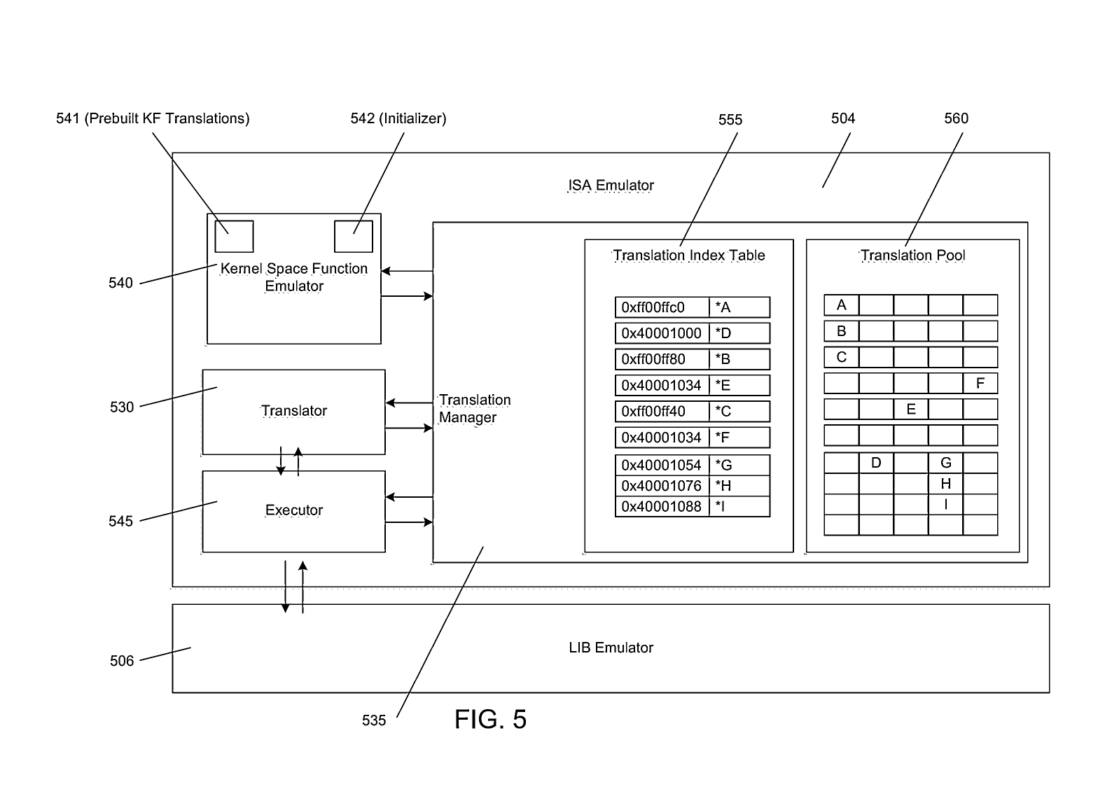

FIG. 5 includes ISA emulator 504, which in turn includes translator 530, translation manager 535, and executor 545. Translator 530 translates source ISA instructions 120 into target ISA instructions 122. As translator 530 translates instructions, translation manager 535 places those translations in translation pool 560, with the translations being indexed in translation index table 555 (e.g., each translation in translation pool 560 is indexed by its entry address). In operation, executor 545 may follow execution flow of application 120 by retrieving a translation with a given IP address and then executing the translated instruction. As described above in various embodiments for FIGS. 1-4, OS services may be emulated via LIB emulator 506. When executor 545 executes an instruction which invokes a LIB API in source ISA 120, executor 545 transfers control to LIB emulator 506, which then emulates the OS service. A similar approach may be used with KFs as is used with the above OS services. However, treating KFs in this manner may cause a context switch as the KF attempts to access privileged kernel areas. This context switch may result in overhead. Moreover, since a KF is recognized by its IP, translator 530 may need to track all KF IPs to recognize the KF and perform the context switch.

FIG. 5, however, includes KF emulator 540 in an embodiment that provides efficient access to kernel data while still providing emulation for other functions. KF emulator 540 includes a set of pre-built KF translations 541 and initializer 542. Prebuilt translations 541 may be structured with the semantics of kernel functions. Initializer 542 works with translation manager 535 to ensure prebuilt KF translations 541 are retrievable via normal executor flow.

For example, at runtime (after translator manager 535 initializes translation index table 555 and initializes translation pool 560) initializer 542 inserts one or more pre-built KF translations 541 (e.g., KF translations A, B, C) into translation pool 560 (which may later be loaded with translations E, F, G, H, I that are not necessarily KF translations) and updates translation index table 555 accordingly. Then, when executor 545 reaches an IP with a kernel function address 541 (e.g., an address corresponding to any of KF translations A, B, C) executor 545 queries translation manager 535 and obtains the corresponding pre-built translation from table 555 and pool 560. Then executor 545 executes the translation, which emulates a kernel function.

With such an embodiment no translation index table misses are produced (e.g., no time is spent looking for a KF translation that has not been created and is consequently not in pool 560/table 555 because those KF translations are already present in pool 560/table 555 due to the earlier acts of initializer 542). Further, such an embodiment avoids the need for translator 530 to track the IPs for KFs. Also, executor/translator context switching is avoided. For example, for KFs LIB emulator 506 is avoided due to the direct calls for KFs located in table 555 and pool 560. Any of the above advantages results in added efficiency for time sensitive KFs.

Thus, embodiments address several shortcomings For example, when dealing with code other than KFs, a translator may start with a given instruction pointer, read the instruction from memory that was pointed to by the instruction pointer, decode the instruction, and then generate the instruction for the target ISA. The translator then moves to the next instruction pointer and repeats the process. When such an application is emulated (e.g., using emulation systems described in conjunction with FIG. 2) the application will not read from a kernel address. Instead, the application uses a kernel API to access kernel functionality. However, with some platforms some KFs in the kernel address range are not protected and are directly exposed to application. Without emulation a platform may contain a call instruction whose target is a kernel address. This presents no issues since the KF is allowed to access the kernel address. But with emulation using disparate source and target ISAs problems may arise. For example, the target platform may not expose the KF to the application in the same way the source ISA expects. If the translator within the emulator (e.g., PVM) tries to read the instruction pointer (following the kernel function call) then the translator may not succeed because the target platform has not treated the KF the same as the source ISA would (e.g., the memory address location for the KF is changed or the KF is otherwise implemented differently). Thus, KFs are special instances that may be handled properly using the embodiments described above (e.g., KF function emulator 540). In an embodiment, the translator recognizes the KF addresses and performs corresponding translations in a manner that differs from normal non-KF functions. For example, the corresponding translation may use a prebuilt translation as described above.

In an embodiment, translation manager 535 may “chain” or otherwise associate a predecessor translation to a successor translation so the execution of the predecessor translation will be transferred to the successor translation without querying the translation index table. This optimization could occur as pre-built translations 541 are prepared. Furthermore, in an embodiment pre-built translations are pinned in translation pool 560 so garbage collection does not remove the translations.

Returning to FIGS. 1 and 2 and embodiments discussed above, when application 120 calls a LIB (e.g., a source LIB) the call is “mapped” (e.g., via gates 224) to target LIB 124 and run on target ISA 122 as follows. Loader 202 loads application binary 120 and resolves undefined symbols in application 120. ISA emulator 204 emulates source ISA 120 “on top of” target ISA 122 to run application 120. LIB emulator 206 emulates the source LIB through mapping to target LIB 124.

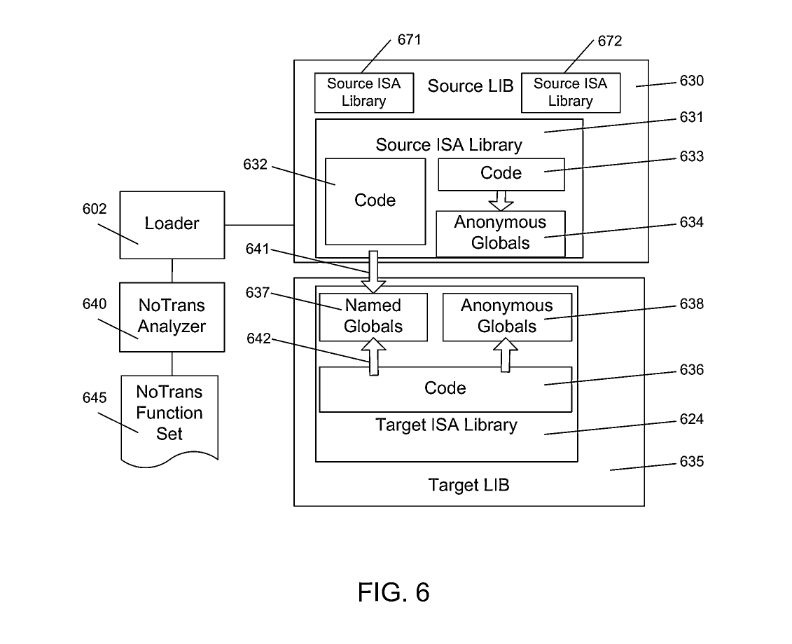

FIG. 6 includes an embodiment for hybrid emulation. One embodiment partly translates a source LIB and partly maps to a target LIB. For example, loader 602 loads some application 120 functions from source LIB 631 in source LIB 630 and emulates other application 120 functions from source LIB 631 through translation and mapping (e.g., as described above with FIGS. 1-4) to target LIB 624 via gates 224.

An attempt to use such a hybrid embodiment may be beneficial for situations when, for instance, some functionality of target LIB 635 is not available for emulation purposes or target LIB 635 does not include semantics identical to source LIB 630 (thereby making emulation challenging). In such a case, avoiding mapping through target LIB 635 (and instead translating the functionality directly) may be beneficial. Furthermore, hybrid emulation may improve application 120 performance in instances when invoking (e.g., calling) a source LIB 630 function and translating the function takes less time than the overhead introduced by the mapping and emulating the same function to target LIB 635.

However, a simple implementation of a hybrid embodiment may create challenges. For example, loader 602 may load specific libraries in source LIB 630 that were previously specified by developers for such loading (i.e., for direct translation and not for mapping via target LIB 635). Such libraries may contain some functions which take less time to directly translate than to emulated and map via target LIB 635 due to the mapping overhead (e.g., delays in transmission incurred due to use of gates 224). However, when source ISA LIB 631 is loaded (and possibly selected from among LIBs 631, 671, 672, etc.) doing so may create a situation where there are two instances of the same LIB (one in source ISA and another in target ISA). The loading of source ISA LIB 631 also brings extra data copies of globals. (The “globals” are global variables whose values can be access and modified by states in a program that are outside of the immediate library or routine that immediately concerns the global.) These extra copies of globals may lead to incorrect results of the source ISA binary 631 since its data values are not synchronized with the original data in the target ISA binary 624. For example, one global (G) is accessed by two functions (F1 and F2). If F1 is to be translated, F1 will use the copy of G located in source ISA library 631. If F2 is to be mapped, F2 will use the copy of G located in target ISA library 624. Then, if F1 writes to the copy of G in source ISA library 631, that change will not be visible to F2 (which uses the copy of G located in target ISA library 624). The same is true if F2 makes a change to its respective copy of G (so the change to G will not be visible to F1).

To address this potential issue, FIG. 6 provides an embodiment for a hybrid environment (e.g., where some calls are translated directly from a source library while other calls are emulated from a target library) that includes both source ISA LIB 631 and target ISA LIB 624. Target LIB 624 shares some or all of the globals (i.e., globals 637) with source ISA LIB 631 (see arrows 641, 642 and the lack of any corresponding arrows between anonymous globals 634, 638). More specifically, the globals are of two kinds: “named” globals 637 and “anonymous” globals 634, 638. (Named globals have symbols associated with them so they can be referred by program modules outside the current libraries. The library code always specifies the corresponding symbol to refer to a named global.) When a source ISA library is loaded, the loader resolves the symbols of named globals to the memory address of the target ISA libraries. However, the anonymous globals 634, 638 do not have associated symbols (e.g., anonymous globals may include a static global in a C language program). After the code is compiled the global is accessed directly with an address having the form of an offset to current instruction point.

FIG. 6 includes “NoTrans Analyzer” 640, an offline logic tool that analyzes source ISA binary 120 and identifies all anonymous globals 638 therein which are not to be translated. If a function from application 120 uses an anonymous global, then that function is collected into a function set deemed “NoTrans Function Set” 645 (i.e., a set of functions that are not to be translated but will instead be mapped and emulated via, for example, gates 224). If a function calls a function in NoTrans Function Set 645, then the function itself is collected into NoTrans Function Set 645. A function in NoTrans Function Set 645 is not allowed to be translated (but is instead mapped).

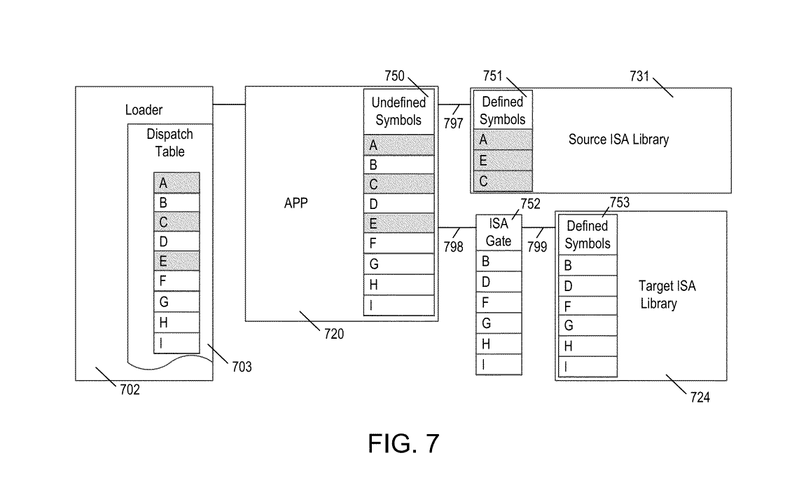

FIG. 7 includes an embodiment concerning loader 602 of FIG. 6. Loader 702 links application 720 with source ISA library 731 (for direct translation of functions) and indirectly maps to target ISA library 724 using a gate from ISA gates 752 (for mapping and emulation of functions). For example, loader 702 corresponds to dispatch table 703, which determines how each undefined symbol is linked. Dispatch table 703 may be prepared by developers. For example, a developer may determine certain symbols need to be translated, such as symbols A, E, C, are those symbols are thus designated for translation from source ISA library 731. However, the developer may determine other symbols, such as symbols B, D, F, G, H, I, are more appropriate for mapping and are accordingly are designated for indirect mapping to target ISA library 724. After loader 702 loads source ISA application 720, loader 702 addresses undefined symbols and tries to resolve them through associating the symbol with the defined symbols of other libraries. For each symbol, if the symbol's corresponding API is to be translated (those designated in the dispatch table 703 as “to be translated”, such as symbols A, E, C) the symbol is linked to symbols exposed by source ISA library 731 (see arrow 797). If the symbol is to be mapped (those designated in the dispatch table as “not to be translated” pursuant to NoTrans Function Set of FIG. 6), it is linked to an ISA gate 752 (see arrow 798), which is associated with symbols 753 exposed by the target ISA library 724. ISA gates 752 may work together with ISA emulator and LIB emulator (e.g., as addressed with FIGS. 1-4) and map a function call in source ISA application 120 to the function implementation in target LIB 724 (see arrow 799).

For ease of understanding various embodiments have been described with one ISA bridging layer 123 bridging one source ISA to one target ISA. However, the present disclosure is not so limited. In embodiments, multiple ISA bridging layers 123 may bridge multiple source ISAs to the target ISA or ISAs. In some of these embodiments, a dispatcher may additionally be provided to detect the bridging required, and instantiate the appropriate ISA bridging layer or layers 123 to provide the required ISA bridging. In other embodiments, some of the resources used for bridging (e.g., some of the wrapper functions) may be located on a remote server accessible to ISA bridging layer 123. Still further, for ease of understanding ISA bridging layer 123 has been described as being configured to bridge a source ISA to a different target ISA. However, for various applications ISA bridging layer 123 may be employed to bridge a source ISA and a target ISA that are the same. In such applications, one or more of the described elements (e.g., binary translation engine 215) may not be needed. An example of such an application may be to provide enhanced operational security to computing device 102. Other applications may likewise benefit from such bridging.

Embodiments may be implemented in code and may be stored on a storage medium having stored thereon instructions which can be used to program a system to perform the instructions. The storage medium may include, but is not limited to, any type of disk including floppy disks, optical disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions. Embodiments of the invention may be described herein with reference to data such as instructions, functions, procedures, data structures, application programs, configuration settings, code, etc. When the data is accessed by a machine, the machine may respond by performing tasks, defining abstract data types, establishing low-level hardware contexts, and/or performing other operations, as described in greater detail herein. The data may be stored in volatile and/or non-volatile data storage. For purposes of this disclosure, the terms “code” or “program” cover a broad range of components and constructs, including applications, drivers, processes, routines, methods, modules, and subprograms. Thus, the terms “code” or “program” may be used to refer to any collection of instructions which, when executed by a processing system, performs a desired operation or operations. In addition, alternative embodiments may include processes that use fewer than all of the disclosed operations, processes that use additional operations, processes that use the same operations in a different sequence, and processes in which the individual operations disclosed herein are combined, subdivided, or otherwise altered. In one embodiment, use of the term control logic includes hardware, such as transistors, registers, or other hardware, such as programmable logic devices. However, in another embodiment, logic also includes software or code. Such logic may be integrated with hardware, such as firmware or micro-code. A processor or controller may include control logic intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like.

Referring to FIG. 1, for one embodiment, at least one of the processor(s) of processor and memory arrangement 104 may be packaged together with the computational logic (or a subset thereof) of ISA bridging layer 123 configured to practice the operations (or a subset thereof) of methods and embodiments of FIGS. 3-7. For one embodiment, at least one of the processor(s) of processor and memory arrangement 104 may be packaged together with the computational logic (or a subset thereof) of ISA bridging layer 123 configured to practice the operations (or a subset thereof) and embodiments of FIGS. 3-7 to form a System in Package (SiP). For one embodiment, at least one of the processor(s) of processor and memory arrangement 104 may be integrated on the same die with the computational logic (or a subset thereof) of ISA bridging layer 123 configured to practice the operations (or a subset thereof) and embodiments of FIGS. 3-7. For one embodiment, at least one of the processor(s) of processor and memory arrangement 104 may be integrated on the same die with the computational logic (or a subset thereof) of ISA bridging layer 123 to form a System on Chip (SoC). For at least one embodiment, the SoC may be utilized in a desktop computer, a laptop computer, a Smartphone, a computing tablet, an Internet appliance, a personal digital assistant (PDA), a portable game playing device, a server or other computing devices.

One embodiment includes a method, is executed by at least one processor, comprising: loading an application having a source instruction set architecture (ISA); storing a first translation of a first source instruction in at least one memory, the first translation being from the source ISA to a target ISA; after storing the first translation, (a) retrieving the stored first translation and executing the translation, and (b) unsuccessfully attempting to find a second translation for the second source instruction and, afterwards, determining the second translation and executing the second translation. The first source instruction may include a kernel function (KF). Storing the first translation may include storing the first translation in a format having an index for translations stored in the at least one memory. The stored first translation may be pinned to avoid removal of the first translation from the at least one memory. The second translation may be determined during runtime for the application. In an embodiment the first source instruction is never emulated and the second the source instruction is emulated for the target ISA. In response to a user selection, a method may include designating a first undefined symbol for translation and designating a second undefined symbol for emulation. An embodiment includes translating a first undefined symbol without emulation and emulating a second undefined symbol. The first and second undefined symbols respectively correspond to first and second anonymous global variables. An embodiment may include emulating the second undefined symbol via a gate that is directed to a target ISA library. An embodiment may include sharing named globals, stored in a target ISA library, with a source ISA library. An embodiment may include resolving a first undefined symbol via translation and without emulation and resolving a second undefined symbol via emulation.

An embodiment may include an application, having a source instruction set architecture (ISA), stored in at least one memory; at least one processor, having a target ISA and coupled to the at least one memory, to perform operations comprising: loading the application; storing a first translation of a first source instruction in the at least one memory, the first translation being from the source ISA to a target ISA; after storing the first translation, (a) retrieving the stored first translation and executing the translation, and (b) unsuccessfully attempting to find a second translation for the second source instruction and, afterwards, determining the second translation and executing the second translation. The first source instruction may include a kernel function (KF). The second translation may be determined during runtime for the application. An embodiment may comprise translating a first undefined symbol without emulation and emulating a second undefined symbol.

It will also be appreciated that the present disclosure may be a solution to the technical problem of providing enhanced security to a computing device. The advantage of the present disclosure may include, but is not limited to, the robustness of the isolation provided.

1. At least one machine readable medium comprising instructions that when executed on a computing device cause the computing device to perform a method comprising:
loading an application having a source instruction set architecture (ISA);
storing a first translation of a first source instruction in at least one memory, the first translation being from the source ISA to a target ISA;
after storing the first translation, (a) retrieving the stored first translation and executing the translation, and (b) unsuccessfully attempting to find a second translation for the second source instruction and, afterwards, determining the second translation and executing the second translation.

2. The at least one medium of claim 1, wherein the first source instruction includes a kernel function (KF).

3. The at least one medium of claim 2, wherein storing the first translation includes storing the first translation in a format having an index for translations stored in the at least one memory.

4. The at least one medium of claim 2, wherein the stored first translation is pinned to avoid removal of the first translation from the at least one memory.

5. The at least one medium of claim 2, wherein the second translation is determined during runtime for the application.

6. The at least one medium of claim 2, wherein the first source instruction is never emulated and the second source instruction is emulated for the target ISA.

7. The at least one medium of claim 1 wherein the method comprises in response to a user selection, designating a first undefined symbol for translation and designating a second undefined symbol for emulation.

8. The at least one medium of claim 1 wherein the method comprises translating a first undefined symbol without emulation and emulating a second undefined symbol.

9. The at least one medium of claim 8, wherein the first and second undefined symbols respectively correspond to first and second anonymous global variables.

10. The at least one medium of claim 8 wherein the method comprises emulating the second undefined symbol via a gate that is directed to a target ISA library.

11. The at least one medium of claim 8 wherein the method comprises sharing named globals, stored in a target ISA library, with a source ISA library.

12. The at least one medium of claim 1 wherein the method comprises resolving a first undefined symbol via translation and without emulation and resolving a second undefined symbol via emulation.

13. (canceled)

14. (canceled)

15. (canceled)

16. An apparatus comprising:
an application, having a source instruction set architecture (ISA), stored in at least one memory;
at least one processor, having a target ISA and coupled to the at least one memory, to perform operations comprising:
loading the application;
storing a first translation of a first source instruction in the at least one memory, the first translation being from the source ISA to a target ISA;
after storing the first translation, (a) retrieving the stored first translation and executing the translation, and (b) unsuccessfully attempting to find a second translation for the second source instruction and, afterwards, determining the second translation and executing the second translation.

17. The apparatus of claim 16, wherein the first source instruction includes a kernel function (KF).

18. The apparatus of claim 17, wherein the second translation is determined during runtime for the application.

19. The apparatus of claim 17, wherein the operations comprise translating a first undefined symbol without emulation and emulating a second undefined symbol.

20. (canceled)

21. A method executed by at least one processor comprising:
loading an application having a source instruction set architecture (ISA);
storing a first translation of a first source instruction in at least one memory, the first translation being from the source ISA to a target ISA;
after storing the first translation, (a) retrieving the stored first translation and executing the translation, and (b) unsuccessfully attempting to find a second translation for the second source instruction and, afterwards, determining the second translation and executing the second translation;
wherein the first source instruction includes a kernel function (KF).

22. The method of claim 21, wherein storing the first translation includes storing the first translation in a format having an index for translations stored in the at least one memory.

23. The method of claim 21, wherein the first source instruction is never emulated and the second source instruction is emulated for the target ISA.

24. The method of claim 21 comprising translating a first undefined symbol without emulation and emulating a second undefined symbol.
